(19) United States
(12) Patent Application Publication
(10) Pub. No.: US 2006/0047782 A1
(43) Pub. Date: Mar. 2, 2006

(54) Presence service

(75) Inventor: Aki Niemi, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/928,110

(22) Filed: Aug. 30, 2004

Related U.S. Application Data
(60) Provisional application No. 60/583,348, filed on Jun. 29, 2004.

(51) Int. Cl. G06F 15/177

(52) U.S. Cl. 709/220

(57) ABSTRACT

A presentity improves presence service and includes a presentity account setup device adapted to cooperate with a presence server of a service provider (LOC_SP) of a local domain. The presentity account setup device includes presentity account definition means, responsive to an instruction input, to define a presentity account at the presence server of the service provider of the local domain by embedding a presentity identification in a domain under which the presentity is registered (ID_of_Presentity@EXT_SP.cc) into a user part of an identification for the local domain (ID_of_Presentity%40EXT_SP.cc@LOC_SP.cc). Further, a correspondingly adapted presence system network entity as well as a correspondingly adapted presence server enable a parking of presence information of a presentity outside its home presence system. Hence, roaming presentities and/or co-location of presentity identities are enabled.

### FIELD OF THE INVENTION

The present invention relates to improvements to presence service, for example in a SIP environment. In particular, the present invention relates to a presentity, a presence server, and a presence system network entity.

### BACKGROUND OF THE INVENTION

Generally, presence is a service and/or technology by means of which a user can publish its availability, and can publish its communications contacts to other interested users.

Availability means for example (basically) that the user has switched on its terminal and is thus basically reachable, or that the user is available within a specific area. In the past, this has been referred to as “on-line” or “off-line”. However, presently the meaning of presence is to be understood in a broader sense and means the willingness and ability of a user to communicate with other users on the network. The availability is thus represented by a configurable presence status definable and/or changeable by presence events.

Communications contacts means for example the user terminal's telephone number such as an MSISDN, an email address, a URI (Uniform Resource Identifier), or any other identification information suitable and/or required for contacting the user via a means of communication he is using and/or via which he is (willing to be) available.

A user of presence, i.e. at least one of the user's terminals subscribed to presence service, is called presentity (a combination of the words “presence” and “entity”).

Such a presentity has an address to which other, interested users—referred to as watchers—subscribe. Such a subscription is accomplished using a presence protocol.

Signaling in connection with publication of presentity's status information and subscription of watchers is referred to as “publish” and “subscribe” messages.

A subscription to presence service results in notifications being sent to a respective watcher, e.g. when the presentity's presence status changes. These messages are commonly referred to as “notify”.

Based on the notifications and/or the contents thereof, respectively, the watcher is enabled to communicate with the presentity, e.g. by being aware of the availability and the communication channel/means to be used and/or to be selected.

Thus, as agreed in current IETF (Internet Engineering Task Force) publications dealing with presence service, a presence service is a system that accepts, stores, and distributes presence information to interested parties, called watchers. A presence protocol is a protocol for providing a presence service over the Internet or any other IP or even just packet-based network.

The terminology as adopted throughout the present specification is intended to be harmonized to agreed IETF terminology; however, the meaning of the expressions used is not intended to be limited by the adopted terminology. Other expressions are intended to be covered also, as long as the same functional (inter)relation is accomplished.

One example of a presence protocol to which reference is made hereinafter for explanatory purposes is thus SIP (Session Initiation Protocol).

Nevertheless, a communications contact of a user needs to be rather static so as to be reachable for communication partners and in order to dispense with notifying all communication partners of a changed communications contact.

In certain communication systems, approaches to maintain a static communications contact have recently been made.

For example, number portability in the mobile phone market has reduced “customer lock-in” (to a specific network operator) by allowing the customer to change the service provider without changing the respective telephone number such as MSISDN.

Furthermore, in the Internet, there exist certain providers who provide forwarding services for home pages and/or email. Thereby, they allow a user to maintain a static email address and/or home page address, while still changing their Internet Service Provider ISP.

With new network technologies evolving, also new service providers will show up.

One of those new network technologies and/or topologies is known as SIP (Session Initiation Protocol). SIP represents a signaling protocol for Internet conferencing, telephony, presence, events notification and instant messaging.

The protocol initiates call setup, routing, authentication and other feature messages to endpoints within an IP domain.

With SIP, and especially the presence service in SIP, the user's SIP service provider needs to be able to handle a user “parking” the presence of an outside SIP address in its system. The same problem most likely exists in the enterprise or business domain, where an employee also has a private SIP identity, and would like to co-locate that presence with the work-identity's presence. Insofar, it could be compared to a “roaming” SIP user.

### SUMMARY OF THE INVENTION

Hence it is an object of the present invention to provide for a system and corresponding devices constituting the same, enabling the parking of the presence of e.g. a SIP address to another SIP service provider.

According to a first aspect of the present invention, this object is for example achieved by
a presentity, comprising: a presentity account setup device adapted to cooperate with a presence server (PS) of a local domain's (LOC_SP) service provider, the presentity account setup device comprising: presentity account definition means, responsive to an instruction input, defining a presentity account at the presence server (PS) of the local domain service provider by embedding the presentity's identification in the domain under which it is registered (ID_of_Presentity@EXT_SP.cc) into a user part of an identification for the local domain (ID_of_Presentity%40EXT_SP.cc@LOC_SP.cc).

According to favorable refinements,
the presentity further comprises a notification device, responsive to the presentity account definition means having defined the presentity account at the presence server (PS) of the local domain service provider, notifying at least one presence system network entity of the domain under which the presentity is registered of the presentity account set up at the presence server of the local domain;
the presentity account setup device comprises: presence server domain detection means detecting the domain of the presence server (PS), and judgment means judging whether the domain (LOC_SP) of the presence server is equal to a domain (EXT_SP) under which the presentity is registered, and adapted to output the instruction input to said presentity account definition means, if said judgment means judge that the presence server domain is not equal to the domain under which the presentity is registered;
said instruction input is manually input by a user of the presentity;
said instruction input comprises at least the presentity's identification in the domain under which it is registered and an identification for the local domain.

According to a second aspect of the present invention, this object is for example achieved by
a presence server (PS) of a local domain (LOC_SP) service provider, comprising
a database (DB) configured to comprise a presentity account associated to a presentity registered under a domain (EXT_SP) that is different from the local domain (LOC_SP).

According to favorable refinements,
the presence server further comprises a communication device for communication with other network entities, the communication device being configured to process presence publication requests and presence subscriptions requests associated to the presentity account maintained at the server which account is associated to a presentity registered under a domain (EXT_SP) that is different from the local domain (LOC_SP);

According to a third aspect of the present invention, this object is for example achieved by
a presence system network entity in a domain under which a presentity is registered, comprising: a communication device for communication with other network entities, wherein the communication device is configured to receive a notification informing of the presentity account, set up for the presentity registered under the domain, at a presence server of a local domain.

According to favorable refinements,
said communication device is configured to redirect all requests directed to the presentity's identification in the domain under which it is registered, to the presentity's presentity account at the presence server (PS) of the local domain service provider;
said communication device is configured to redirect based on an address binding of presentity's identification in the domain under which it is registered to the presentity's presentity account at the presence server (PS) of the local domain service provider.

Also, according to an aspect of the present invention, this object is achieved by
a method for parking a presence, the method comprising embedding a presentity identification in a domain under which a presentity is registered into a user part of an identification for a local domain; and defining a presentity account at a presence server of a service provider of the local domain responsive to an instruction input.

According to favorable refinements, the method comprises
notifying at least one presence system network entity of the domain under which the presentity is registered of the presentity account set up at the presence server of the local domain;
detecting the local domain of the presence server;
judging whether the local domain of the presence server is equal to the domain under which the presentity is registered; and
outputting the instruction input if the judging step determines that the local domain is not equal to the domain under which the entity is registered.

Hence, according to the present invention, the following exemplary advantages are achieved:
the invention enables thus a parking of presence information of a presentity outside its “home” presence system,
“roaming” presentities and/or co-location of presentity identities is enabled,
for a service provider, such a kind of service can be “packaged” to the services it provides and can be separately charged for,
the proposed solution is thus easy to implement to the existing SIP infrastructure, without significant modifications; the implementation is accomplished in either hardware or software.

### BRIEF DESCRIPTION OF THE DRAWINGS

The present invention will be described with reference to the accompanying drawings, in which

FIG. 1 shows in rough outline entities of a presence system according to the present invention,

FIG. 2 shows as a block circuit diagram a presentity according to the present invention,

FIG. 3 shows as a block circuit diagram a presence server according to the present invention, and

FIG. 4 shows as a block circuit diagram a presence system network entity according to the present invention.

### DETAILED DESCRIPTION OF EMBODIMENTS OF THE INVENTION

Accordingly, as has been outlined above, the present invention, stated in brief an in other words, comprises:

A) Setting Up a Presence Park-Account:

A special account (parking account) that is to be used to park the external identity's presence in the (local) presence system is configured in the (local) service provider. This is manually configured by the user, or automatically by the presentity.

An example of such an account could be the following (assuming that user.name is the identification of the presentity ID_of_presentity in the external service provider's domain EXT_SP, e.g. located in Finland FI)
SIP: user.name%40ext_sp.fi@int_sp.fi (user.name@ext_sp.fi escaped and inserted in the user-part of the Uniform Resource Identifier URI)
   B) Configuration at the External Service Provider:

The external service provider, i.e. its presence system network entity or entities, is configured and/or set to perform a proxying operation, i.e. to proxy or redirect, all e.g. SIP based requests to the target domain (i.e. the local domain). With reference to the above example, there is provided an address binding of SIP:user.name@ext_sp.fi
->SIP:user.name%40ext_sp.fi@int_sp.fi
   C) Configuration at the Internal Service Provider

The internal service provider, i.e. its presence system network entity or entities, is a configured such that both presence publications (“Publish”) and presence subscriptions (“Subscribe”) are accepted for SIP:user.name%40ext_sp.fi@int_sp.fi. Those messages will reach the internal service provider's network entities at least upon being redirected from the external service provider's presence system network entities.

The overall implementation resides in an implementation of the above configurations at the respective network nodes concerned.

This will be set out in greater detail herein below.

Subsequently, the present invention will be described with reference to an example concerning a presence system and corresponding entities enabling the parking of the presence of a SIP address to another SIP service provider. Also, corresponding method steps for enabling proper operation of the system and entities involved will be described.

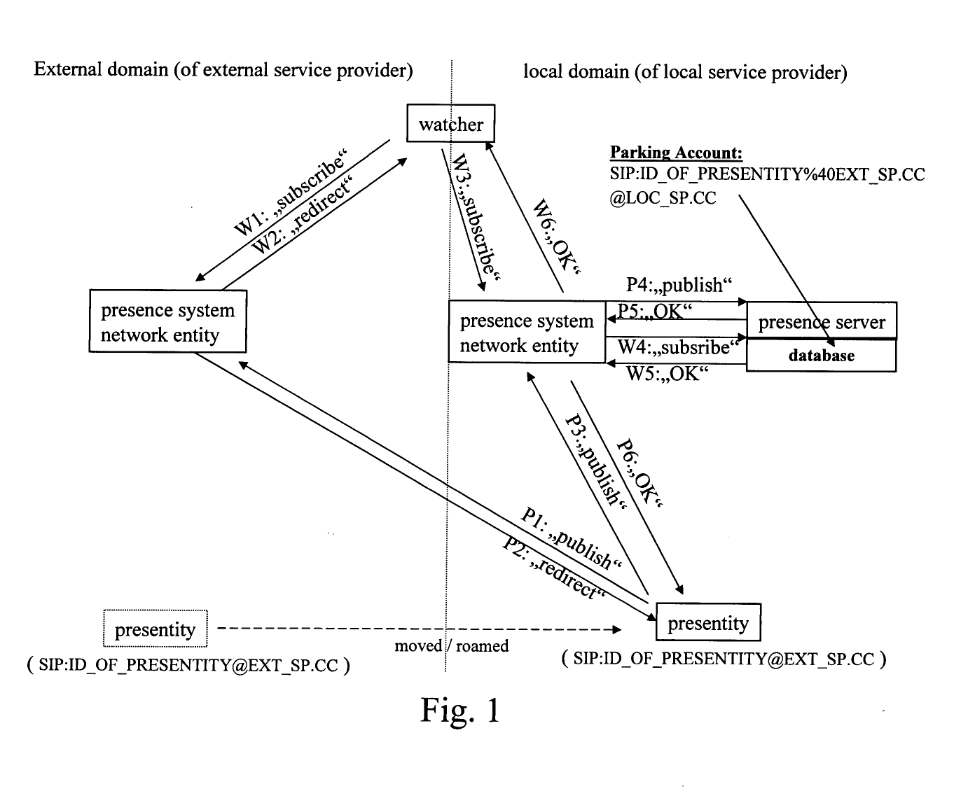

FIG. 1 shows in rough outline entities of a presence system according to the present invention. It is to be noted that FIG. 1 shows a state in which the system has already been appropriately configured, the process of obtaining such a configuration being described afterwards.

As shown in FIG. 1, the presence system involves two domains. A so-called external domain of an external service provider denotes the domain under which a presentity is (initially) registered and identified. The presentity (shown in dotted representation in the lower left part of FIG. 1) is registered with an identification such as SIP:ID_of_Presentity@EXT_SP.CC, assuming that SIP is used as an example here. EXT_SP denotes the external service provider and cc denotes a country code, for example, or any other top-level domain extension. The external domain is represented by a presence system network entity of the external domain. This does not exclude that more than one presence system network entities and/or other network entities constitute the external domain, but is chosen for the purpose of a simplified explanation only.

The presentity is shown in bold outline in the lower right part of FIG. 1 as being present in a local domain of a local service provider LOC_SP. The top-level domain of the local service provider is also represented by e.g. a country code cc; however, the “country codes” of the external and local domains need not be the same, although represented both by cc. The presentity is present in the local domain due to being moved or roamed thereto. However, the external and local domains need not be spatially separated from each other, but do only need to be logically/administratively distinct from each other. Thus, the presentity, i.e. its user, being located at the same location, may just “decide” to communicate within and/or via another (e.g.: the local) domain. For example, the external domain could represent a private service provider, whereas the local domain could represent a work service provider such as the user of the presentiy's employer having established and running its own domain.

The local domain is represented by a presence system network entity of the local domain. This does not exclude that more than one presence system network entities and/or other network entities constitute the external domain, but is chosen for the purpose of a simplified explanation only.

In addition, the local domain is represented by a presence server, associated to which is a database. At the database, so-called parking accounts are maintained for presentities not registered in the local domain, but for example registered in the external domain.

The external presentity is thus addressable in the local domain via its parking account. This parking account is established by defining the presentity's parking account at the presence server of the local domain service provider by embedding the presentity's identification in the domain under which it is registered (ID_of_Presentity@EXT_SP.cc) into a user part of an identification for the local domain (ID_of_Presentity%40EXT_SP.cc@LOC_SP.cc).

In the upper part of FIG. 1 a watcher is shown. The watcher is assumed to be interested in the presence status of the presentity and issues “subscribe” messages to the presence system network entity, as will be set out in greater detail hereinafter.

Subsequently, messages shown in FIG. 1 will be explained. Note that FIG. 1 shows only part of the messages exchanged in the system and illustrates only those aspects of the message flow related to the present invention, while others are not shown/explained.

Messages and/or signaling of the presentity are denoted with “P”, followed by a number indicating the sequence of messages.

Firstly, the presentity publishes its presence status (e.g. upon the occurrence of a status (change) event to the presence system network entity of its home network domain, i.e. the external domain; message P1.

This presence system network entity is thus in a domain under which the presentity is registered, and comprises a communication device for communication with other network entities. The communication device is configured to receive a notification informing of the presentity account, set up for the presentity registered under the domain, at a presence server of a local domain. In the illustrated scenario, such a notification has recently already been received by a notifying message (not shown in FIG. 1).

Further, the communication device is configured to redirect all requests directed to the presentity's identification in the domain under which it is registered, to the presentity's presentity account at the presence server of the local domain service provider. Thus, as shown in FIG. 1, the presentity is informed by a message P2 of the redirection.

Thereafter, the presentity's publish message is redirected to the presence system network entity of the local domain, message P3.

Such a redirection is due to the communication device being configured to redirect messages based on an address binding of the presentity's identification in the domain under which it is registered to the presentity's presentity account at the presence server of the local domain service provider.

Alternatively, it is also possible that message P2 is not transmitted (but instead a redirection decision is taken internally in the network entity of the external domain and is processed), but that then message P3 is forwarded and/or relayed, i.e. redirected from the presence system network entity of the external domain “directly”, i.e. at least without involving the presentity again, to the presence system network entity of the local domain.

The presence system network entity of the local domain transmits the publish message, P4, further to the presence server and the associated database, so that the presence account of the presentity is accordingly updated.

In response to a successful update of the presence status of the presentity at the parking account, an ok message is returned, P5, via the presence system network entity and further to the presentity, P6.

Substantially the same basic message flow is valid for subscribe messages from a watcher to the presentity's presence information.

Messages and/or signaling of the watcher are denoted with “W”, followed by a number indicating the sequence of messages.

Firstly, the watcher subscribes to the presence status of the presentity to the presence system network entity of the presentity's home network domain, i.e. the external domain; message W1, because the presentity is firstly known to the watcher only by its identification in the domain, under which the presentity is registered.

As stated above, this presence system network entity is thus in a domain under which the presentity is registered, and comprises a communication device for communication with other network entities. The communication device is configured to receive a notification informing of the presentity account, set up for the presentity registered under the domain, at a presence server of a local domain. In the illustrated scenario, such a notification has recently already been received by a notifying message (not shown in FIG. 1).

Further, the communication device is configured to redirect all requests directed to the presentity's identification in the domain under which it is registered, to the presentity's presentity account at the presence server of the local domain service provider. Thus, as shown in FIG. 1, the watcher is informed by a message W2 of the redirection.

Thereafter, the watcher's subscribe message is redirected to the presence system network entity of the local domain, message W3.

Such a redirection is due to the communication device being configured to redirect messages based on an address binding of the presentity's identification in the domain under which it is registered to the presentity's presentity account at the presence server of the local domain service provider.

Alternatively, it is also possible that message W2 is not transmitted (but instead a redirection decision is taken internally in the network entity of the external domain and is processed), but that then message W3 is forwarded and/or relayed, i.e. redirected from the presence system network entity of the external domain “directly”, i.e. at least without involving the watcher again, to the presence system network entity of the local domain.

The presence system network entity of the local domain transmits the publish message, W4, further to the presence server and the associated database, so that the watcher may subscribe to the presence account of the presentity and learn any updates contained therein.

In response to a subscription to the presence status of the presentity at the parking account, an ok message is returned, W5, via the presence system network entity and further to the watcher, W6.

The external service provider's presence system network entity is thus enabled to perform an unconditional forwarding using redirect/proxying. The watcher subscribes to the presentity's external identity's presence and follows redirection responses and points the request to the correct, i.e. the local domain. The presentity publishes its presence documents associated with its external identity and redirection/proxying works also (at the presence system network entity) for publication messages. The presence server maintains a parking account, i.e. a parking type identity. In this regard, it is to be noted that the request-URI and the presentity (entity attribute in presence document) are not the same.

It is to be noted that the publish messages of the presentity P are not in a specific timing relation to the subscribe messages of the watcher, but that subscribe and publish messages are rather independent from each other.

Hereinbefore, the system and interrelation of entities constituting the system has been described. Subsequently, details of the entities will be described with reference to a respective block circuit representation thereof.

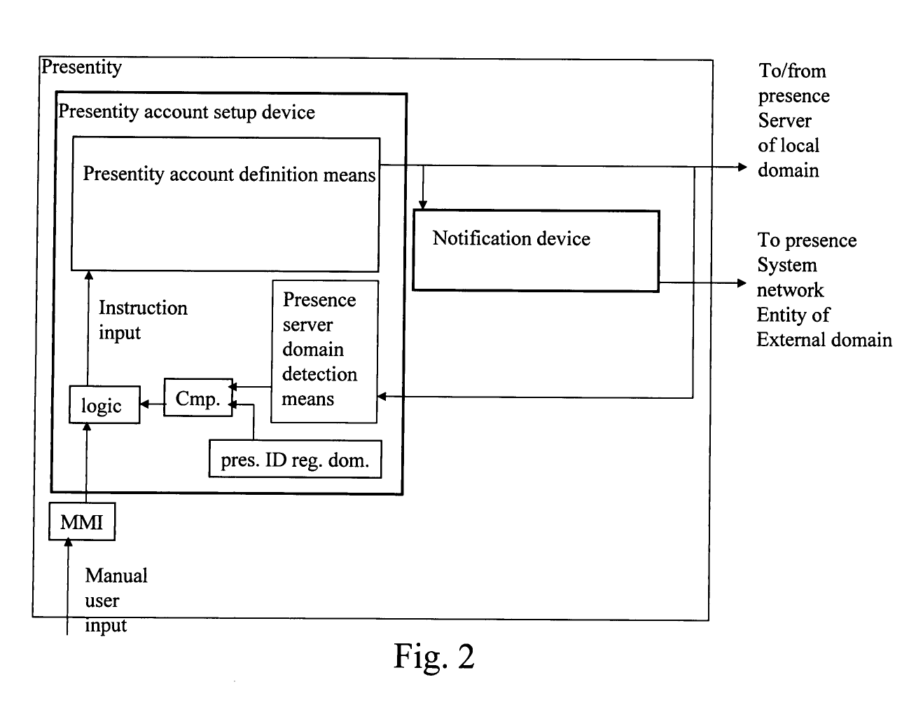

FIG. 2 shows as a block circuit diagram a presentity according to the present invention.

As shown, the presentity comprises a presentity account setup device, which is adapted to cooperate with a presence server of a local domain's LOC_SP service provider.

The presentity account setup device in turn comprises a presentity account definition means, which is responsive to an instruction input. The definition means as configured to define a presentity account at the presence server of the local domain service provider. This is accomplished, for example, by embedding the presentity's identification in the domain under which it is registered, i.e. ID_of_Presentity@EXT_SP.cc, into a user part of an identification for the local domain such as e.g. ID_of_Presentity%40EXT_SP.cc@LOC_SP.cc.

In addition, the presentity further comprises a notification device, which is responsive to the presentity account definition means having defined the presentity account at the presence server of the local domain service provider. For example, the signal supplied to the presence server also triggers the notification device. The notification device is configured to notify at least one presence system network entity of the domain under which the presentity is registered, i.e. of the external domain, of the presentity account set up at the presence server of the local domain.

Still further, the presentity account setup device comprises a presence server domain detection means, which is configured to detect the domain of the presence server. For example, in a discovery operation, the presence server domain detection means learns the domain of the presence server. A judgment means judges whether the domain LOC_SP of the presence server is equal to a domain EXT_SP under which the presentity is registered. The domain under which the presentity is registered is e.g. fetched from an internal memory storing the domain under which the presentity's ID is registered. The judgment means is adapted to output the instruction input to said presentity account definition means, if said judgment means judge that the presence server domain is not equal to the domain under which the presentity is registered.

The instruction input can be directly input to the definition means in one embodiment.

Alternatively, in another embodiment, the instruction input can directly be manually input by a user of the presentity to the definition means via a man machine interface MMI.

Nevertheless, as shown in FIG. 2, in the illustrated specific embodiment both possibilities are combinedly present. Then, the output of the judgment means (comparison means cmp) and the input from a man machine interface NMI of the presentity are passed via a logic circuit. The logic circuit evaluates both inputs, e.g. by a priorization in that a manual input overrules the other input, or vice versa. The output of the logic circuit, i.e. only one of its inputs is then supplied to the definition mean as an instruction input.

In any case, the instruction input comprises at least the presentity's identification in the domain under which it is registered and an identification for the local domain.

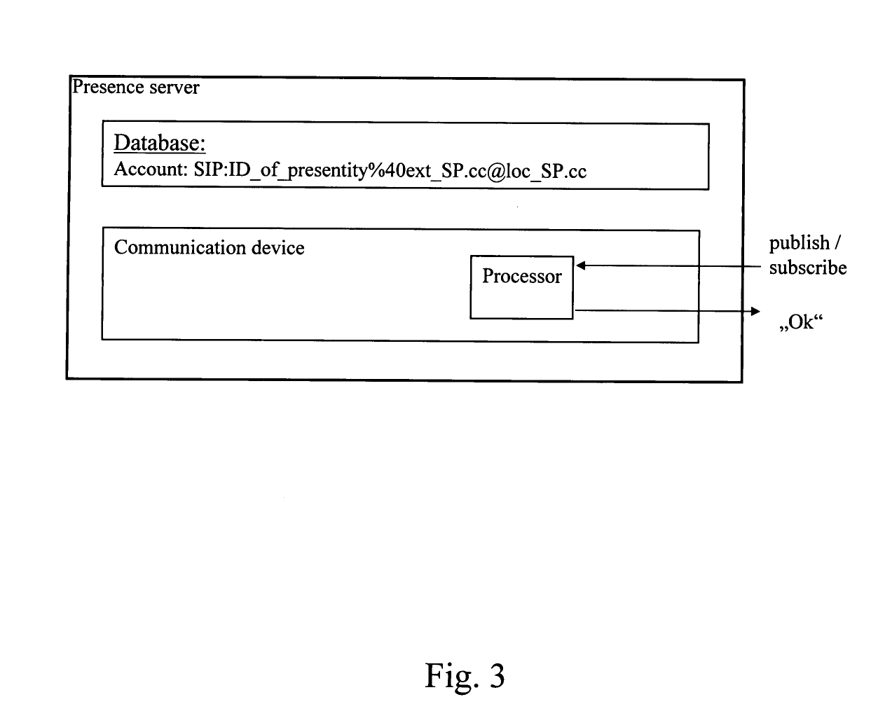

FIG. 3 shows as a block circuit diagram a presence server according to the present invention.

The presence server of a local domain LOC_SP service provider comprises a database configured to comprise a presentity account associated to a presentity registered under a domain EXT_SP that is different from the local domain LOC_SP. In the example shown, this account is identified by SIP:ID_of_presentity%40ext_SP.cc@int_SP.cc.

The presence server comprises further a communication device configured to accomplish communication with other network entities. The communication device is particularly configured to process presence publication requests and presence subscriptions requests associated to the presentity account maintained at the server which account is associated to a presentity registered under a domain EXT_SP that is different from the local domain LOC_SP. Thos publish/subscribe requests are received due to the forwarding/redirecting of these requests, as described herein above. Upon processing those requests, the communication device is also adapted to respond to these requests with an OK message (in case of success) or with any other suitable message reflecting the processing result and conforming to the presence protocol chosen in the system, such as SIP.

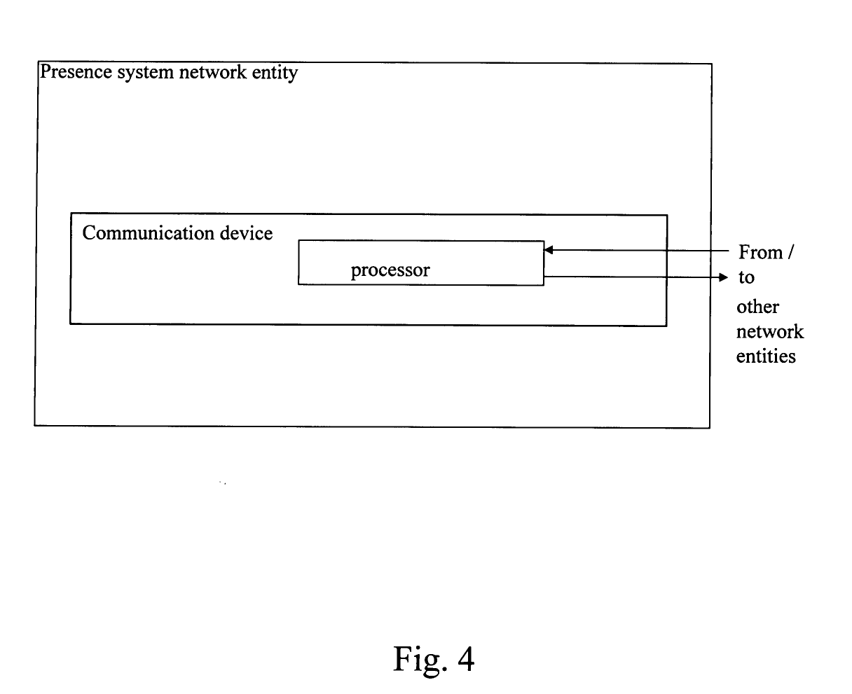

FIG. 4 shows as a block circuit diagram a presence system network entity according to the present invention.

The presence system network entity, in a domain under which a presentity is registered, comprises a communication device for communication with other network entities. The communication device is configured to receive a notification informing of the presentity account, set up for the presentity registered under the domain, at a presence server of a local domain. Such a notification triggers the communication device with regard to a further configuration.

Namely, additionally, having received such a notification, said communication device is configured to redirect all requests directed to the presentity's identification in the domain under which it is registered, to the presentity's presentity account at the presence server of the local domain service provider. The redirection processing is e.g. based on an address binding of presentity's identification in the domain under which it is registered to the presentity's presentity account at the presence server of the local domain service provider.

As described herein before, the present invention provides a presentity, comprising: a presentity account setup device adapted to cooperate with a presence server of a local domain's (LOC_SP) service provider, the presentity account setup device comprising: presentity account definition means, responsive to an instruction input, defining a presentity account at the presence server of the local domain service provider by embedding the presentity's identification in the domain under which it is registered (ID_of_Presentity@EXT_SP.cc) into a user part of an identification for the local domain (ID_of_Presentity%40EXT_SP.cc@LOC_SP.cc). The invention also concerns a correspondingly adapted presence system network entity as well as a correspondingly adapted presence server. The invention enables thus a parking of presence information of a presentity outside its “home” presence system. Hence, roaming presentities and/or co-location of presentity identities is enabled.

Although the present invention has been described herein above with reference to certain embodiments and variations thereof, it is to be understood that the present invention is not limited thereto. Rather, various modifications are further conceivable within the scope of the appended claims.

1. A presentity, comprising:
a presentity account setup device configured to cooperate with a presence server of a service provider of a local domain,
wherein the presentity account setup device comprises
presentity account definition means, responsive to an instruction input, to define a presentity account at the presence server of the service provider of the local domain by embedding a presentity identification in a domain under which the presentity is registered into a user part of an identification for the local domain.

2. A presentity according to claim 1, further comprising:
a notification device, responsive to the presentity account definition means having defined the presentity account at the presence server of the service provider of the local domain, to notify at least one presence system network entity of the domain under which the presentity is registered of the presentity account set up at the presence server of the local domain.

3. A presentity according to claim 1, wherein
the presentity account setup device comprises
presence server domain detection means to detect the local domain of the presence server, and
judgment means to judge whether the local domain of the presence server is equal to the domain under which the presentity is registered, and configured to output the instruction input to said presentity account definition means, if said judgment means judge that the local domain of the presence server is not equal to the domain under which the presentity is registered.

4. A presentity according to claim 1, wherein
said instruction input is manually input by a user of the presentity.

5. A presentity according to claim 1, wherein said instruction input comprises at least the presentity identification in the domain under which the presentity is registered and the identification for the local domain.

6. A presence server of a service provider of a local domain, the presence server comprising:
a database configured to comprise a presentity account associated to a presentity registered under a domain that is different from the local domain.

7. A presence server according to claim 6, further comprising
a communication device for communication with other network entities, the communication device configured to process presence publication requests and presence subscriptions requests associated to the presentity account maintained at the server, wherein the presentity account is associated to the presentity registered under the domain that is different from the local domain.

8. A presence system network entity in a domain under which a presentity is registered, the presence system network entity comprising:
a communication device for communication with other network entities, wherein the communication device is configured to receive a notification informing of a presentity account at a presence server of a service provider of a local domain set up for a presentity registered under a domain.

9. A presence system network entity according to claim 8, wherein said communication device is configured to redirect all requests directed to a presentity identification in the domain under which the presentity is registered, to the presentity account at the presence server of the service provider of the local domain.

10. A presence system network entity according to claim 9, wherein said communication device is configured to redirect based on an address binding of the presentity identification in the domain under which the presentity is registered to the presentity account at the presence server of the service provider of the local domain.

11. A method for parking a presence, the method comprising:
embedding a presentity identification in a domain under which a presentity is registered into a user part of an identification for a local domain; and
defining a presentity account at a presence server of a service provider of the local domain responsive to an instruction input.

12. The method of claim 11, further comprising
notifying at least one presence system network entity of the domain under which the presentity is registered of the presentity account set up at the presence server of the local domain.

13. The method of claim 11, further comprising
detecting the local domain of the presence server.

14. The method of claim 13, further comprising
judging whether the local domain of the presence server is equal to the domain under which the presentity is registered.

15. The method of claim 14, further comprising
outputting the instruction input if the judging step determines that the local domain is not equal to the domain under which the entity is registered.
